(19) United States
(12) Patent Application Publication
(10) Pub. No.: US 2025/0074316 A1
(43) Pub. Date: Mar. 6, 2025

(54) COVERING ELEMENT FOR A VEHICLE SEAT, ASSOCIATED SEAT AND MANUFACTURING METHOD

(71) Applicant: Faurecia Sièges d'Automobile, Nanterre (FR)

(72) Inventors: Raymonde ODRION, Mélisey (FR); Ivan POPOVIC, La Bruyere (FR)

(21) Appl. No.: 18/814,906

(22) Filed: Aug. 26, 2024

(30) Foreign Application Priority Data
Aug. 31, 2023 (FR) FR 2309177

(51) Int. Cl. B60R 7/00; B60N 2/70

(52) U.S. Cl. CPC B60R 7/005; B60N 2/70

(57) ABSTRACT

A vehicle seat covering element that includes: a central portion having an upper edge; an upper portion having a lower edge; two side portions secured to the central portion; and a pocket portion having a first edge and a second edge opposite one another, the pocket portion delimiting a storage space. The first edge is secured to the upper edge of the central portion and the second edge is secured to the lower edge of the central portion. The pocket portion is folded on itself, with the first edge and the second edge together delimiting an opening for access to the storage space, and the upper portion is secured to the side portions on either side of the opening.

### TECHNICAL FIELD

The present invention relates to a covering element for a vehicle seat. The invention also relates to a vehicle seat comprising such a covering element and a method for manufacturing such a covering element.

### BACKGROUND

In the field of vehicle seats, it is known to equip seat covering elements with pockets forming storage spaces. Such pockets are particularly appreciated by vehicle users, as they enable them to store some of their accessories.

Previously known pockets, for example, can fully accommodate a mobile device such as a cell phone. Such pockets are formed, for example, by sewing a pocket portion over a portion forming the outer surface of a seat cover element.

However, such pockets are not entirely satisfactory. In fact, the part forming the pocket and the seams joining the part forming the pocket to the part forming the outer surface of the seat cover element are visually unsatisfactory. Thus, even if such pockets can accommodate a mobile device, the aesthetics of such pockets are unsatisfactory.

### SUMMARY

One of the aims of the invention is then to provide a seat covering element comprising a storage space that is visually satisfactory.

To this end, the invention relates to a vehicle seat covering element comprising:
a central portion comprising an upper edge,
an upper portion comprising a lower edge,
two side portions arranged on either side of the central portion and integral with the central portion, and
a pocket portion comprising a first edge and a second edge opposite one another, the pocket portion delimiting a storage space,
the first edge of the pocket portion being secured to the upper edge of the central portion and the second edge of the pocket portion being secured to the lower edge of the central portion, the pocket portion being folded on itself to form two pocket sections, the first edge and the second edge together delimiting an opening for access to the storage space, the upper portion being attached to the side portions on either side of the opening.

Because the opening is delimited by the first and second edges, and since the first edge is attached to the upper edge and the second edge is attached to the top edge, the opening extends in the continuity of a junction between the upper portion and the central portion, such continuity being particularly aesthetic.

According to other advantageous aspects of various embodiments of the invention, the vehicle seat covering element comprises one or more of the following features, taken alone or in any technically feasible combination:
the upper portion is also secured to the central portion on either side of the opening, between the opening and each side portion;
the pocket portion comprises a third and a fourth edge connecting the first and second edges to one another, the two pocket sections being secured to one another along the third and fourth edges as well as along a fold line extending away from the opening relative to the pocket portion;
the pocket portion is enclosed between its first and second edges;
the lining element comprises a protective plate, the protective plate being arranged at least partially between the pocket portion and the central portion;
the protective plate is attached to the pocket portion along the third and fourth edges of the pocket portion;
the protective plate is secured to the pocket portion by a seam arranged at a distance substantially between 3 mm and 7 mm from the third and fourth edges of the pocket portion; and
the length of the pocket sections measured orthogonally to the first and/or second edge defines a storage space depth, the storage space depth being substantially between 5 mm and 20 mm

The invention further relates to a seat comprising at least one support element comprising a body and a seat covering element as aforesaid, said covering element covering at least a portion of the body.

The invention further relates to a method for manufacturing a seat covering element comprising the following steps:
securing the two side portions to the central portion;
securing the first edge of the pocket portion to the upper edge of the central portion and securing the second edge of the pocket portion to the lower edge of the upper portion;
folding the pocket portion to form two pocket sections;
securing the upper portion to the side portions on either side of the opening delimited by the first and second edges of the pocket portion.

### BRIEF DESCRIPTION OF THE DRAWINGS

The invention will be better understood on reading the following description, given solely by way of non-limiting example, and referring to the drawings in which:

FIG. 1 is a schematic front depiction of a seat comprising a seat covering element according to an embodiment of the invention;

FIG. 2 is a schematic cross-sectional depiction of the seat of FIG. 1 along a cutting plane P-P′ passing through the pocket; and

FIG. 3 is a schematic depiction in perspective of the seat of FIGS. 1 and 2.

### DETAILED DESCRIPTION

In the remainder of the description, the terms “front” and “rear” as well as “upper” and “lower” are used to refer to a seat with the front corresponding to the direction in which a seat user's legs extend, as opposed to the term rear, and the top/upper region of the seat corresponding to the direction towards which a seat user's head extends, as opposed to the bottom/lower region of the seat.

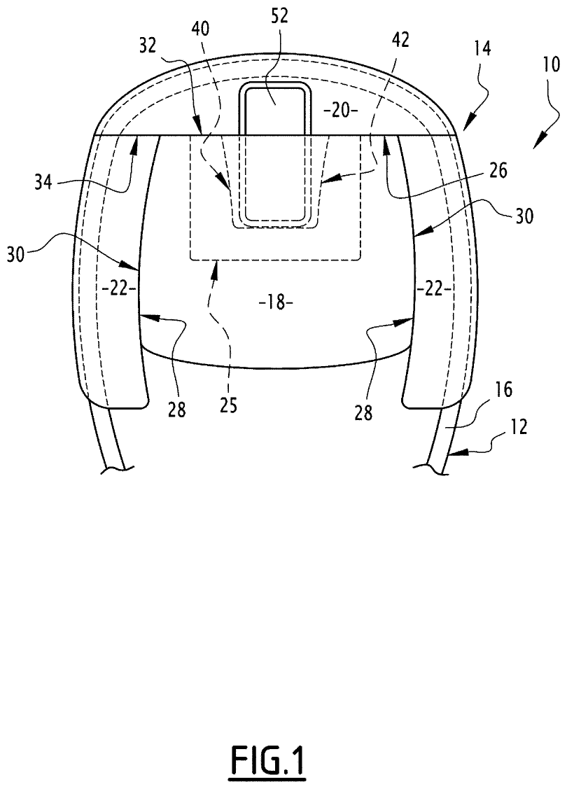

Referring to FIG. 1, a vehicle seat 10 comprises a support element 12 and a seat covering element 14.

The vehicle seat 10 is for example installed in a vehicle passenger compartment (not shown), such as a motor vehicle.

The support element 12, for example a seat backrest, comprises a body 16 defining an internal structure of the seat 14. The support element 12 also comprises a base (not shown), for example, the base securing the body 16 to a floor (not shown) of the vehicle or to another seat support element, such as a seat bottom. It is understood that in various embodiments the invention can be applied to any type of seat support element, such as the seat bottom, a headrest, an armrest or the like.

For example, body 16 comprises at least one reinforcing section, such as a metal frame, and includes padding, such as foam padding, covering the reinforcing segment (not shown).

As shown in FIG. 1, where the body 16 covered by the covering element 14 is shown in dotted lines, the covering element 14 at least partially covers a portion of the body 16

The covering element 14 is for example an element intended to cover a seat back and is for example a seat back covering element.

As shown in FIGS. 1 to 3, the seat cover element 14 comprises a central portion 18, an upper portion 20, two side portions 22 and a pocket portion 24.

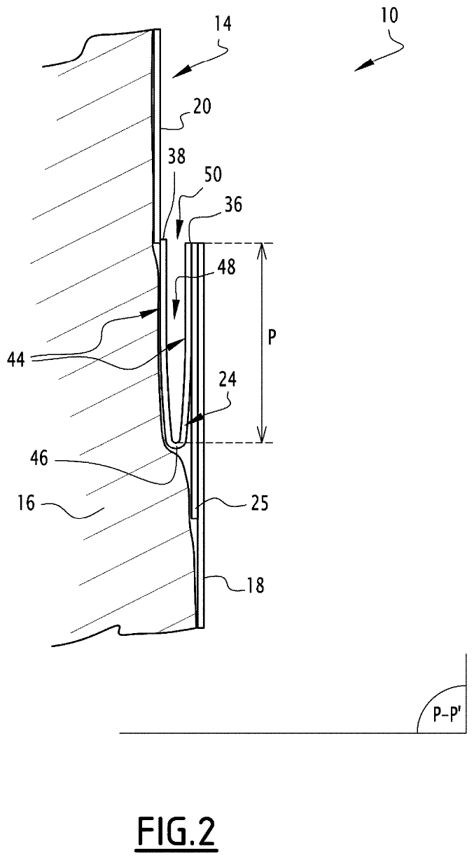

As shown in FIG. 2, the seat cover element 14 also comprises a protective plate 25, for example.

The seat cover element 14 extends, for example, over a rear face of the body 16 to form the back of a seat back 10.

The seat covering element 14 is intended, for example, to extend opposite another seat (not shown) arranged to the rear of the seat 10 comprising the seat covering element 14.

In an embodiment not shown, the seat covering element 14 comprises other parts extending, for example, over a front of the body 16, such a seat covering element 14 forming, for example, a cover for the seat 10.

The seat cover 14 is made of textile or leather, for example. The seat cover element 14, for example, is made of a natural and/or synthetic material.

In one particular embodiment, each of the central portion 18, upper portion 20, side portions 22 and pocket portion 24 are formed by a fabric, for example cloth. In one embodiment, the fabric forming the pocket portion 24 is thinner and of a different type than the fabrics forming the other portions 18, 20, 22. In other embodiments, the fabrics of all portions are of similar thickness and/or type, or the fabrics of each part are of different thickness and/or type

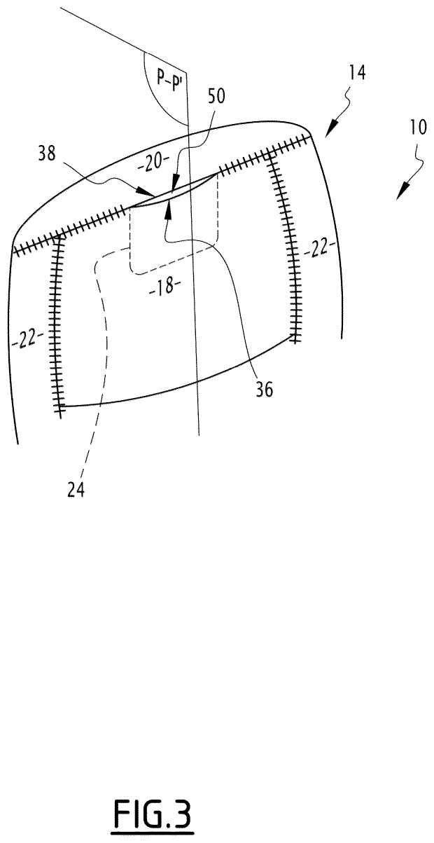

As shown in FIGS. 1 and 3, the central portion 18 comprises an upper edge 26 and two side edges 28, connected to the upper edge 26 and extending on either side of the central portion 18.

As shown in FIGS. 1 and 3, the two side portions 22 are arranged on either side of the central portion 18 and are integral with the central portion 18.

For example, each side portion 22 comprises a side edge 30 secured, for example zipped, for example by means of a zip fastener, or sewn, to one of the side edges 28 of the central portion 18 (see FIG. 3 for a schematic representation of securing by sewing).

As shown in FIGS. 1 and 3, the upper portion 20 comprises a lower edge 32. The upper portion, for example, forms an apex of the covering element 14, that is, the uppermost element of the covering element 14 in the frame of reference of the seat 10.

As shown in FIGS. 1 and 3, the upper portion 20 is secured, for example sewn, to the side portions 22. In particular, the lower edge 32 is secured to the upper edges 34 of each of the side portions 22 (see, for example, FIG. 3 for a schematic representation of securing by sewing).

As shown in FIGS. 1 to 3, the lower edge 32 of the upper portion 20 extends opposite the upper edge 26 of the central portion 18.

As shown in FIG. 2, the pocket portion 24 comprises a first edge 36 and a second edge 38 opposite one another. The pocket portion further comprises a third edge 40 and a fourth edge 42 connecting the first 36 and second 38 edges together.

As shown in FIG. 2, pocket section 24 is folded over to form two pocket panels 44, for example along a fold line 46. In particular, pocket section 24 is folded onto itself along fold line 46, with fold line 46 joining the two pocket sections 44. The fold line 46 extends substantially between the first edge 36 and the second edge 38, for example, so that the two pocket panels are similar in shape. In one embodiment, pocket portion 24 is formed by two portions sewn together, for example sewn along fold line 46.

The two pocket panels 44 are also joined together along the third and fourth edges. The two pocket panels are sewn together along the third and fourth edges, for example by a seam (not shown) extending between 3 and 7 mm from the third 40 and fourth 42 edges.

The pocket portion 24 defines a storage space 48. In particular, the two panels 44 joined together along the fold line 46 and the third 40 and fourth 42 edges define between them the storage space 48. The fold line 46 forms the bottom of the storage space 48

The first edge 36 and the second edge 38 together define an access opening 50 to the storage space 48. The access opening 50 extends away from fold line 46 relative to pocket portion 24.

As shown in FIG. 1, a user can, for example, insert a mobile device 52 such as a cell phone into the storage space 48 by sliding such a device 52 through the access opening 50.

As shown in FIG. 2, a length of the pocket panels 44 measured orthogonally to the first 36 and/or second 38 edge defines a depth P of the storage space 48. The depth P of the storage space 48 then corresponds to the distance between the fold line 46 on the one hand, and the first edge 36 and/or the second edge 38 on the other. When the fold line 46 extends substantially equidistant between the first edge 36 and the second edge 38, the depth P of the storage space 48 corresponds to the distance between the fold line 46 on the one hand and the first edge 36 or the second edge 38 on the other hand, this distance being the same whether measured with respect to the first 36 or the second edge 38

The depth P of the storage space is, for example, between 50 mm and 200 mm.

The depth P is chosen, for example, to leave a portion of a conventional-sized mobile device, such as a smartphone, outside the pocket, to leave a portion of a display surface of the mobile device visible from outside the pocket, or to make it easier to grip the device from the pocket. Alternatively, the depth can be chosen to accommodate the entire device.

The pocket portion 24 is, for example, enclosed between its first edge 36 and its second edge 38. As the pocket portion 24 is folded onto itself, a length of the fold line 46 is thus less than the lengths of the first 36 and second 38 edges. In this case, each of the sections 44 is flared, for example, from the fold line 46 towards the first 36, or possibly second 38, edge. The storage space 48 is thus flared towards access opening 50.

The first edge 36 of the pocket portion 24 is secured, for example sewn, to the upper edge 26 of the central portion 18 and the second edge 38 of the pocket portion 24 is secured, for example sewn, to the lower edge 32 of the upper portion 20. The access opening 50 thus extends between the upper edge 26 of central portion 18 and the lower edge 32 of upper portion 20.

As can be seen in FIG. 3, the upper portion 20 is then secured, for example sewn, to the side portions 22 on either side of the access opening 50 (see FIG. 3 for a schematic illustration of securing by sewing)

In one particular embodiment, and as shown in FIG. 3, the upper portion 20 is also for example secured, for example sewn, to the central portion 18 on either side of the access opening 50, between the opening 50 and each side portion 22. Thus, and according to this embodiment, the lower edge 32 of the upper portion 20 and the upper edge 26 of the central lower portion are free from one another only at the access opening 50, to allow access to the storage space 48.

The protective plate 25 has a thickness of between 2 mm and 10 mm. The protective plate 25 is, for example, a carpet plate.

As shown in FIG. 2, the protective plate 25 is arranged at least partially between the pocket portion 24 and the central portion 18. In particular, the protective plate 25 extends between one of the panels 44 and the central portion 18.

In particular, the protective plate 25 extends over at least the entirety of one of the panels 44. In other words, the protective plate 25 is larger than the panel over which the protective plate 25 extends, so that the protective plate 25 completely covers this panel 44.

The protective plate 25 is preferably secured to the pocket portion 24. The protective plate 25, for example, is secured to the pocket portion 24 along the third and fourth edges of the pocket portion 24. The protective plate 25, for example, is secured to the pocket portion 24 by a seam arranged at a distance substantially between 3 mm and 7 mm from the third 40 and fourth 42 edges of the pocket portion 24.

The protective plate 25, for example, is configured to protect the storage space, for example by absorbing shocks between the storage space 48 and the central portion 18 of the pocket.

In a particular example, the seam securing the pocket panels 44 to one another is separate from the seam securing the pocket portion 24 to the protective plate 25. In another example, a single seam simultaneously secures the pocket sections 44 to one another and the pocket section 24 to the protective plate 25.

A method for manufacturing a covering element 14 as described above will now be presented.

The two side portions 22 are first secured to the central portion 18. The two side portions 22 are, for example, sewn to the central portion 18 along the side edges 28 of the central portion 18.

The first edge 36 of the pocket portion 24 is then secured, for example sewn, to the upper edge 26 of the central portion 18 and the second edge 38 of the pocket portion 24 is secured, for example sewn, to the lower edge 32 of the upper portion 20. In particular, the first 36 and second 38 edges of pocket portion 24 are secured to the upper edge 26 of central portion 18 and lower edge 32 of upper portion 20 before pocket portion 24 is folded along its fold line 46.

The pocket section 24 is then folded to form the two pocket panels 44.

The pocket panels 44 thus formed are then secured together along the third 40 and fourth 42 edges, for example.

When the lining element 14 comprises a protective plate 25, the protective plate 25 is further secured to the pocket portion 24, for example along the third 40 and fourth 42 edges.

The upper portion 20 is then secured, for example sewn, to the side portions 22 on either side of the access opening 50 delimited by the first 36 and second 38 edges of the pocket portion 24.

The upper portion 20 is also secured, for example sewn to the central portion 18, on either side of the opening 50, between the opening 50 and each side portion 22.

As seen from above, the pocket portion 24 of such a seat covering element and the edges 40, 42 of such a pocket portion are thus not visible from outside the seat covering element, such an element proving particularly aesthetic, the pocket thus formed not being visible to vehicle passengers, particularly when not in use.

Securing the upper portion 20 to the central portion 18 on either side of the opening 50 is particularly advantageous for forming a small opening 50, particularly suitable for holding modern mobile devices securely in the covering element 14.

Enclosing the pocket portion 24 between its first 36 and second 38 edges results in a storage space 48 flared towards the opening 50 once the pocket portion 24 is folded onto itself, such a storage space 48 facilitating the insertion of objects into the storage space 48.

The presence of a protective plate 25 and the particular arrangement of this protective plate 25 in the covering element 14 is particularly relevant to prevent damage to the central portion 18 by objects placed in the storage space 48 or to prevent damage to objects placed in the storage space 48 from the central portion 18.

The position of the seam securing the pocket portion 24 to the protective plate 25 ensures the robustness of the covering element 14.

The depth P of the storage space 48 as specified above is particularly advantageous as it allows a mobile electronic device such as a cell phone to be partially accommodated, while allowing a portion of the device to extend outside the storage space 50. This is particularly advantageous for holding the device in the covering element 14 while allowing a user to view information displayed on a portion of the device.

1. A vehicle seat covering element comprising:
a central portion comprising an upper edge,
an upper portion comprising a lower edge,
two side portions arranged on either side of the central portion and integral with the central portion, and
a pocket portion comprising a first edge and a second edge opposite one another, the pocket portion delimiting a storage space,
the first edge of the pocket portion being secured to the upper edge of the central portion and the second edge of the pocket portion being secured to the lower edge of the central portion, the pocket portion being folded on itself to form two pocket panels, the first edge and the second edge together delimiting an access opening to the storage space, the upper portion being secured to the side portions on either side of the opening.

2. The seat cover element according to claim 1, wherein the upper portion is further secured to the central portion on either side of the opening, between the opening and each side portion.

3. The seat cover element according to claim 1- or 2, wherein the pocket portion comprises third and fourth edges connecting the first and second edges to one another, the two pocket portions being secured to one another along the third and fourth edges as well as along a fold line extending away from the opening relative to the pocket portion.

4. The seat covering element according to claim 1, wherein the pocket portion is enclosed between its first and second edges.

5. The seat covering element according to claim 1, comprising a protective plate, the protective plate being arranged at least partially between the pocket portion and the central portion.

6. The seat covering element according to claim 5, wherein the protective plate is secured to the pocket portion along the third and fourth edges of the pocket portion.

7. The seat covering element according to claim 6, wherein the protective plate is secured to the pocket portion by a seam arranged at a distance substantially of between 3 mm and 7 mm from the third and fourth edges of the pocket portion.

8. The seat covering element according to claim 1, wherein the length of the pocket panels measured orthogonally to the first and/or second edge defines a depth of the storage space, the depth of the storage space being substantially between 5 mm and 20 mm.

9. A seat comprising at least one support element comprising a body and the seat covering element according to claim 1, said covering element covering at least a portion of the body.

10. A method for manufacturing the seat covering element according to claim 1, comprising the following steps:
securing the two side portions to the central portion;
securing the first edge of the pocket portion to the upper edge of the central portion and securing the second edge of the pocket portion to the lower edge of the upper portion;
folding the pocket portion to form two pocket panels; and
securing the upper portion to the side portions on either side of the opening delimited by the first and second edges of the pocket portion.
